(19) United States
(12) Patent Application Publication
(10) Pub. No.: US 2025/0360675 A1
(43) Pub. Date: Nov. 27, 2025

(54) MULTI-AXIS 3D PRINTER

(71) Applicant: BOARD OF REGENTS FOR THE OKLAHOMA AGRICULTURAL AND MECHANICAL COLLEGES, STILLWATER, OK (US)

(72) Inventor: Hadi Noori, Stillwater, OK (US)

(21) Appl. No.: 18/872,423

(22) PCT Filed: Jun. 14, 2023
(86) PCT No.: PCT/US2023/025263

§ 371 Date: Dec. 6, 2024

Related U.S. Application Data
(60) Provisional application No. 63/352,111, filed on Jun. 14, 2022.

(51) Int. Cl. B29C 64/209; B29C 64/118; B29C 64/232; B29C 64/236; B29C 64/393; B33Y 10/00; B33Y 30/00; B33Y 50/02

(52) U.S. Cl. CPC B29C 64/209; B29C 64/118; B29C 64/232; B29C 64/236; B29C 64/393; B33Y 10/00; B33Y 30/00; B33Y 50/02

(57) ABSTRACT

A system has a printing platform, a first print head that is configured to deposit material along a first deposition axis, and a second print head that is configured to deposit material along a second deposition axis that is not parallel to the first deposition axis. At least one actuator is configured to cause relative movement between the printing platform and the first and second print heads along a vertical axis and first and second horizontal axes.

### CROSS-REFERENCE TO RELATED APPLICATION

This application claims priority to and the benefit of the filing date of U.S. Provisional Patent Application No. 63/352,111, filed Jun. 14, 2022, the entirety of which is hereby incorporated by reference herein.

### FIELD

This application relates to systems and methods for 3D printing and, in particular, to 3D printing in at least one direction that is not downward (e.g., not parallel to a vertical axis).

### BACKGROUND

3D printing enables on-demand manufacturing of complex designs for various applications in different industries. The layer-by-layer construction of parts in 3D printing can provide opportunities to customize products' properties for specific service conditions. For example, the layer's material, height, and orientation can be changed to customize printed parts' physical or mechanical properties. The individualized processing of each layer has opened new horizons for 3D printing of multifunctional materials and structures. However, the limitations of available printers in the individualized processing of each layer challenge the application of 3D printing in multifunctional materials manufacturing. For instance, the building direction in conventional extrusion-based printings is perpendicular to the motional plane of the print head (nozzle), limiting or preventing the print head from depositing layers parallel to the print head axis.

### SUMMARY

Disclosed herein, in one aspect, is a system having a vertical axis, a first horizontal axis that is perpendicular to the vertical axis, and a second horizontal axis that is perpendicular to the vertical axis and the first horizontal axis. The system includes a printing platform, a first print head that is configured to deposit material along a first deposition axis; and second print head that is configured to deposit material along a second deposition axis that is not parallel to the first deposition axis. At least one actuator is configured to cause relative movement between the printing platform and the first and second print heads along the vertical axis and the first and second horizontal axes.

Methods of using the system are also disclosed.

Additional advantages of the disclosed system and method will be set forth in part in the description which follows, and in part will be understood from the description, or may be learned by practice of the disclosed system and method. The advantages of the disclosed system and method will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the disclosed apparatus, system, and method and together with the description, serve to explain the principles of the disclosed apparatus, system, and method.

FIG. 1 is a schematic diagram of an exemplary 3D printing system as disclosed herein.

FIG. 2 is a perspective view of an exemplary 3D printing system as disclosed herein.

FIG. 3A illustrates a printed object on a bending fixture. FIG. 3B illustrates a close-up of the sample comprising two segments P and S that were formed by first and second print heads, respectively.

FIG. 4A illustrates an OSU logo printed by a horizontally printing print head. FIG. 4B illustrates two wedge segments that combine to form a cuboid, one wedge segment printed by a horizontally printing print head, and one wedge segment printed by a vertically printing print head

FIG. 5 shows a plot of a typical load-displacement curve for conditions 1 and 2 samples without interface fracture.

FIG. 6A-6D show a comparison of four samples with through-thickness fracture types. Specifically, FIG. 6A shows condition 1, sample without interface debonding; FIG. 6B shows conditioning 2, sample without interface debonding; FIG. 6C shows interface debonding (fracture) on condition 1; and FIG. 6D shows interface fracture on condition 2.

FIG. 7 is a block diagram of an exemplary operating environment comprising a computing device as disclosed herein.

FIG. 8 shows an exemplary printed object and a support platform printed on a printing platform of the system as disclosed herein.

FIG. 9 shows a perspective view of an exemplary 3D printing system as disclosed herein.

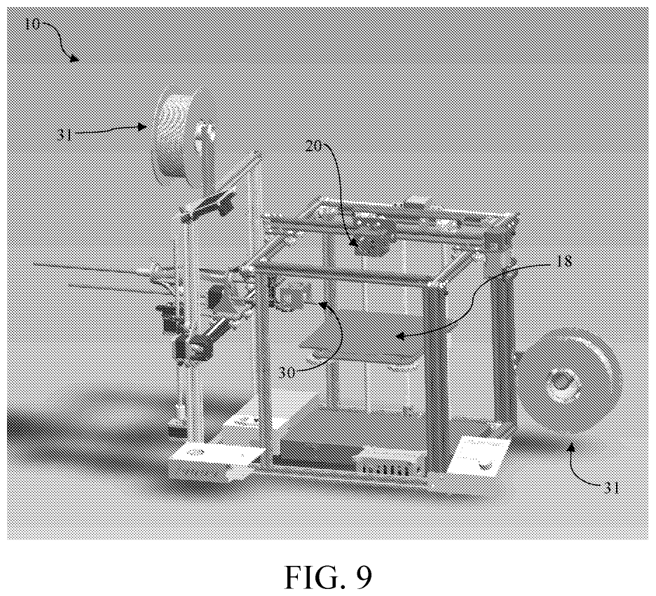

### DETAILED DESCRIPTION

The disclosed system and method may be understood more readily by reference to the following detailed description of particular embodiments and the examples included therein and to the Figures and their previous and following description.

It is to be understood that the terminology used herein is for the purpose of describing particular embodiments only and is not intended to limit the scope of the present invention which will be limited only by the appended claims.

It must be noted that as used herein and in the appended claims, the singular forms “a,” “an,” and “the” include plural references unless the context clearly dictates otherwise. Thus, for example, reference to “a print head” includes one or more of such print heads, and so forth.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Optionally, in some aspects, when values or characteristics are approximated by use of the antecedents “about,” “substantially,” or “generally,” it is contemplated that values within up to 15%, up to 10%, up to 5%, or up to 1% (above or below) of the particularly stated value or characteristic can be included within the scope of those aspects.

Unless defined otherwise, all technical and scientific terms used herein have the same meanings as commonly understood by one of skill in the art to which the disclosed apparatus, system, and method belong. Although any apparatus, systems, and methods and materials similar or equivalent to those described herein can be used in the practice or testing of the present apparatus, system, and method, the particularly useful methods, devices, systems, and materials are as described.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step. As used in the specification and in the claims, the terms “comprises” and “comprising” can include the aspects “consists of,” “consisting of,” “consists essentially of,” and/or “consisting essentially of.”

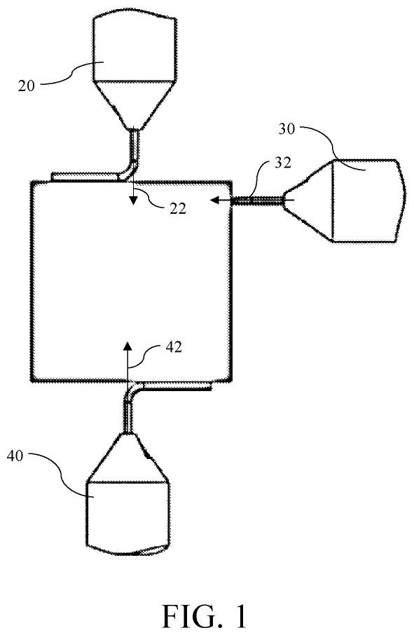

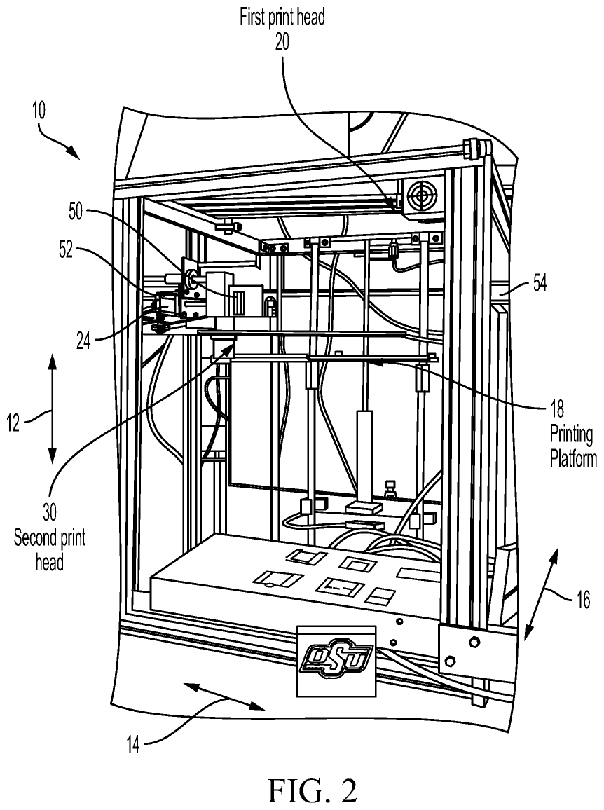

Disclosed herein and with reference to FIGS. 1-2, is a system 10 for 3D printing. The system has a vertical axis 12, a first horizontal axis 14 that is perpendicular to the vertical axis, and a second horizontal axis 16 that is perpendicular to the vertical axis and the first horizontal axis. The system 10 can comprise printing platform 18. The system 10 can further comprise a first print head 20 that is configured to deposit material along a first deposition axis 22. At least one actuator 24 can be configured to effect relative movement between the first print head 20 and the printing platform along the vertical axis 12 and the first and second horizontal axes 14, 16. A second print head 30 can be configured to deposit material along a second deposition axis 32 that is not parallel to the first deposition axis 22.

In some aspects, the first deposition axis 22 can be parallel to the vertical axis 12.

In further optional aspects, the second deposition axis 32 can be perpendicular to the first deposition axis 22. For example, the first deposition axis 22 can be vertical, and the second deposition axis 32 can be horizontal.

In various optional aspects, the system can further comprise a third print head 40 that is configured to deposit material along a third deposition axis 42 that is not parallel to the first or second deposition axes.

In some aspects, the third deposition axis can be perpendicular to the first and second deposition axes 22, 32. For example, the first deposition axis 22 can be vertical, the second deposition axis 32 can be horizontal, and the third deposition axis 42 can be horizontal and perpendicular to the first and second deposition axes. In further aspects, the third deposition axis 42 can be vertical and in a direction opposite the first deposition axis. In some optional aspects, the second print head can be omitted, and the system 10 can include the first and third print heads that are configured to print in opposite directions.

In still further aspects, it is contemplated that the first, second, and/or third deposition axes can be angularly oriented to one another at a desired orientation other than parallel or perpendicular. For example, it is contemplated that where the deposition axes are disclosed herein as being perpendicular or parallel to one another, it is contemplated that in other aspects, the disclosed angular orientations within about 15 degrees or within about 10 degrees of the disclosed angular relationship. It is contemplated that printing direction can affect structural features of a printed object. For example, as further described herein with reference to the examples, printing direction can affect adhesion strength of printed filaments to a printed object (e.g., determining adhesion strength between printed layers). Accordingly, objects printed by the disclosed apparatus can have greater strength and be less subject to delamination.

In exemplary aspects, each print head can be configured to print a respective filament size. In some aspects, each respective filament size can the same as, or different from that of each other print head.

Each print head can receive material from a respective source 31 for deposition. In some aspects, the material deposited by each of the print heads (e.g., the first, second, and third print heads) can be the same material. In other aspects, the material can differ in at least one property. For example, the material from each print head can have a different color and/or be a different type of polymer and/or comprise at least one additive not present in the material printed by each other print head. It is contemplated that different materials can be printed to form a composite material. In further aspects, the different materials printed by each head can have different electrical properties. For example, the system 10 can be configured to print circuits or batteries or portions thereof. Filaments from each print head can be subject to different environmental factors, such as pressure or light. In this way, different material properties can be imparted by each print head.

In filament-based printing, by which a filament (e.g., comprising printable polymer or polymer-matrix-composite) is extruded, each print head can be utilized to print filaments with different chemical compositions. Therefore, multiscale composites can be created in which different geometrical blocks of 3D structure comprise customized chemical composition and geometry (including layer material, layer height, layer width, and infill pattern). Moreover, each layer of a 3D block comprising multiple layers can have a different chemical composition (filler contents, where fillers can be polymers, metals, ceramics, or a combination thereof). In some aspects, customizing layers and blocks of 3D structure can impart devised anisotropy in mechanical and physical properties of prints beyond conventional technology and can provide advanced multifunctional designs. For example, a 3D-printed object with a specific material composition, layer(s) height, and orientation can be embedded at the core of a 3D-printed shell, which differs from the 3D-printed object within the core of the shell in one or more printing aspects. The core can, therefore, have special mechanical or physical properties different from the shell structure to meet the desired design specifications. More generally, multiscale composite manufacturing with different properties (geometrical and material properties) at different scales is feasible using multi-axis 3D printing as disclosed herein.

In some aspects, the at least one actuator 24 can comprise a first linear actuator that is configured to move the printing platform 18 relative to each of the first and second print heads 20, 30 along the vertical axis, a second linear actuator that is configured to move the printing platform relative to each of the first and second print heads along the first horizontal axis, and a third linear actuator that is configured to move the move the printing platform relative to each of the first and second print heads along the second horizontal axis. Each of the first, second, and third linear actuators can comprise, for example, servo motors or stepper motors that move the respective print head along a respective track.

In alternative aspects, the at least one actuator 24 can comprise, for each print head: a first linear actuator 50, that is configured to move a respective one of the first, second, or third print heads 20, 30, 40 along the vertical axis 12, a second linear actuator that is configured to move the respective print head along the first horizontal axis 14, and a third linear actuator that is configured to move the respective print head along the second horizontal axis 16. Each of the first, second, and third linear actuators can comprise, for example, servo motors or stepper motors that move the respective print head along a respective track. Accordingly, relative movement between each print head and the printing platform 18 can be effected by movement of the platform or by movement of the print head.

Optionally, at least one respective actuator can be configured to move each of the first and second print heads 20, 30 along the vertical axis 12 and the first and second horizontal axes 14, 16 relative to the printing platform 18.

Optionally, a plurality of print heads (e.g., the first, second, and/or third print heads 20, 30, 40) can print simultaneously. In this way, printed objects can be formed more rapidly than by using a single print head.

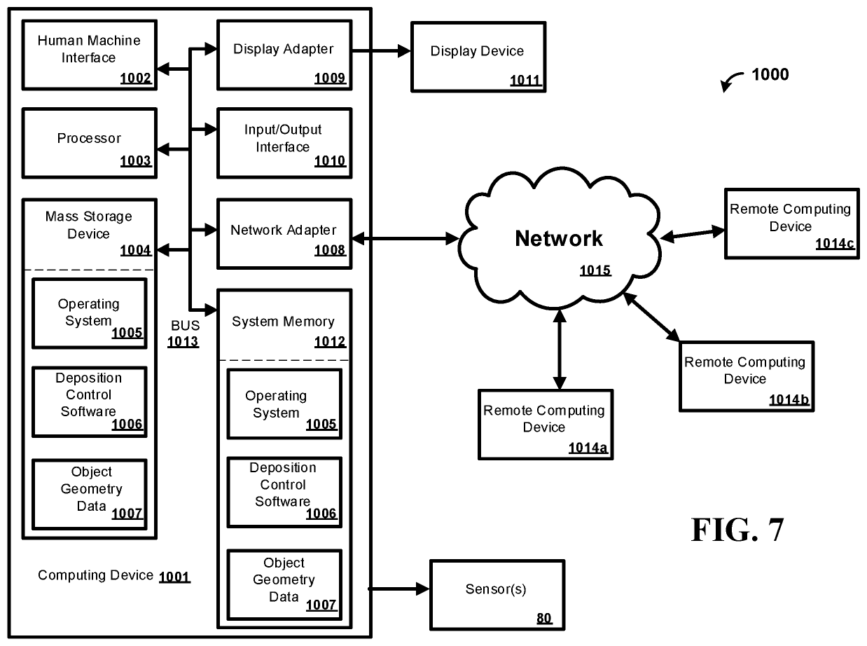

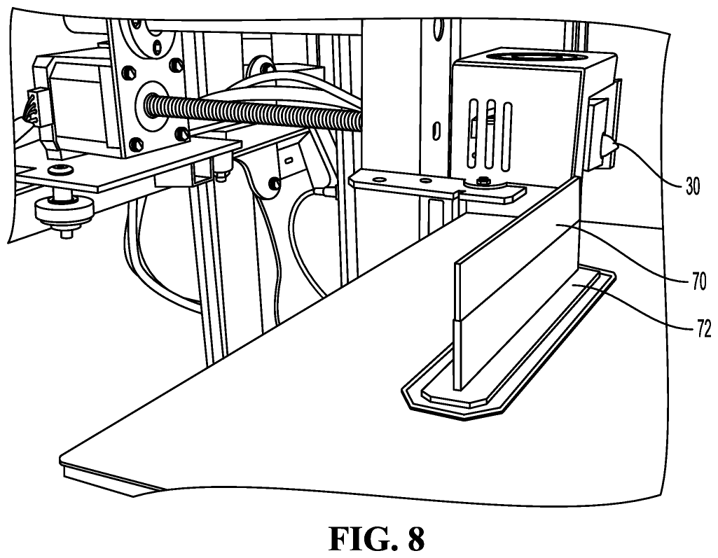

The system 10 can further comprise a computing device 1001. The computing device 1001 (also shown in FIG. 7) can be in communication with the first and second print heads 20, 30 (and any additional print heads) and the actuators 24 that are configured to move the respective print heads relative to the printing platform. The computing device 1001 can be configured as described further herein. The computing device 1001 can comprise at least one processor (e.g., processor 1003) and a memory (e.g., mass storage device 1004) in communication with the at least one processor. The memory can comprise instructions that, when executed by the at least one processor, cause the system to: a) move, by the at least one actuator, the first print head; b) deposit, by the first print head, material to form a first portion of a printed object 70 (FIG. 8); c) move, by the at least one actuator, the second print head relative to the first portion of the printed object; and d) deposit, by the second print head, material to or on the first portion of the printed object to form a second portion of the printed object. Accordingly, the computing device can coordinate movement of the first and second print heads. Similar coordination can be provided when three or more print heads are used.

In some optional aspects, the memory can comprise instructions that, when executed by the at least one processor, cause the system to move the second print head relative to the first portion of the printed object based on properties of the material deposition sequence followed by the first print head to produce the first portion of the printed object. That is, the computing device 1001 can determine the structure of, and the position of, the deposited material based on one or more properties of the deposition of the material completed by a given print head. For example, the computing device can determine the location of each print head as the material is deposited (e.g., extruded) from each print head. The computing device 1001 can therefore determine the location and shape of the printed object. It is further contemplated that the computing device can track and store relative positions of the first print head relative to the second print head. Similarly, when three or more print heads are provided, it is contemplated that the computing device can track and store relative positions of the three or more print heads based on the location and movement profile of the print heads during and after deposition of material.

In further aspects, the system 10 can comprise at least one sensor that is configured to detect spatial geometry of the first portion of the printed object. Each sensor of the at least one sensor, or a plurality of sensors collectively, can be configured to detect a particular structure of the printed object, such as, for example, a surface, an edge, or a corner. In this way, portions of the printed object can be determined to allow for deposition of additional material on or to surfaces of the printed object such that a selected geometric profile for the associated stage of object deposition can be achieved. For example, it is contemplated that during a sequence associated with a particular portion of the printed object, the at least one processor can cause the system to deposit material in a manner that achieves a geometric profile corresponding to that stage in the printing/deposition process (so that subsequent material deposition can properly align with previously deposited material). Similarly, during a sequence associated with a final portion of the printed object, the at least one processor can cause the system to deposit material in a manner that achieves a complete or final geometric profile of the printed object. As can be understood, position of the print head relative to the object being printed can be critical. Thus, precise determination of positions of the print head(s) and/or printed material can be advantageous.

The memory can comprise instructions that, when executed by the at least one processor, cause the system to: a) detect, by the at least one sensor, spatial geometry of the first portion of the printed object; and b) move the second print head relative to the first portion of the printed object based on the spatial geometry detected by the at least one sensor. For example, it is contemplated that the at least one processor can cause the system 10 to move the second print head in a manner that adjusts the spacing of the second print head relative to the first portion of the printed object in accordance with a geometric profile (e.g., height, angular orientation, depth, width, curvature, etc.) associated with the second portion of the printed objection to be deposited by the second print head. A similar process can be followed during deposition of subsequent portions of the printed object, regardless of the print head(s) being used. In exemplary aspects in which multiple print heads are printing simultaneously, it is contemplated that the processor can cause the system to coordinate movement among the print heads so that (a) the print heads (for example, nozzles of the print heads) do not contact one another; and/or (b) the print heads do not simultaneously deposit material at the same location on the printed object. For example, it is contemplated that the at least one sensor can comprise a plurality of sensors (for example, and without limitation, proximity sensors and/or optical sensors) that are configured to detect physical locations of respective print heads. In still other aspects, it is contemplated that the processor can be configured to coordinate and monitor movement of the respective print heads by determining spatial geometry of one or more surfaces of the printed object as the print heads deposit material. In these aspects, it is contemplated that changes in the spatial geometry can be indicative of movement of one or more print heads within the system. It is further contemplated that the processor can selectively control a sequence of movement of the print heads in a manner that additively builds upon the previously deposited material while maintaining coordinated movement. In some exemplary aspects, it is contemplated that each print head can be coupled to a track (or other suitable stop element) that mechanically limits movement of the print head in a manner that geometrically prevents interference with other print heads.

In some optional aspects, the at least one sensor can comprise one or more optical sensors. In further aspects, the at least one sensor can comprise at least one contact sensor that is configured to sense contact with the printed object. Such contact sensors can comprise, for example, piezoelectric sensors.

In some aspects, the second print head 30 cannot print directly on the printing platform 18. For example, it is contemplated that the second print head 30 can extend parallel to, or generally parallel to, the printing platform 18. Thus, in some configurations, the second print head 30 can have an outlet that requires a clearance from the printing platform in order to prevent the second print head 30 and associated actuators and hardware from crashing into the printing platform.

Accordingly, in some aspects, a method of using the system 10 can comprise depositing material to form a support section 72 on a printing platform 18 of the system and depositing material to or on the support section to form the printed object. For example, the first print head 20 can deposit the material to form the support section 72. The support section 72 can have a sufficient dimension (e.g., height) to permit the second print head 30 to deposit material to or on the support section (or a printed object printed on the support section).

The support section 72 can subsequently be separated from the printed object 70.

### Computing Device

FIG. 7 shows an operating environment 1000 including an exemplary configuration of a computing device 1001 for use with the system 10 (FIG. 1).

The computing device 1001 may comprise one or more processors 1003, a system memory 1012, and a bus 1013 that couples various components of the computing device 1001 including the one or more processors 1003 to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data such as printed object geometry data 1007 and/or program modules such as operating system 1005 and deposition control software 1006 that are accessible to and/or are operated on by the one or more processors 1003.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and deposition control software 1006 may be stored on the mass storage device 1004. One or more of the operating system 1005 and deposition control software 1006 (or some combination thereof) may comprise program modules and the deposition control software 1006. The printed object geometry data 1007 may also be stored on the mass storage device 1004. The printed object geometry data 1007 may be stored in any of one or more databases known in the art. The databases may be centralized or distributed across multiple locations within the network 1015.

A user may enter commands and information into the computing device 1001 using an input device. Such input devices comprise, but are not limited to, a joystick, a touchscreen display, a keyboard, a pointing device (e.g., a computer mouse, remote control), a microphone, a scanner, tactile input devices such as gloves, and other body coverings, motion sensor, speech recognition, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display 1011 and computing device 1001 may be part of one device, or separate devices.

The computing device 1001 may operate in a networked environment using logical connections to one or more remote computing devices 1014a,b,c. A remote computing device 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computing device 1001 and a remote computing device 1014a,b,c may be made using a network 1015, such as a local area network (LAN) and/or a general wide area network (WAN), or a Cloud-based network. Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices 1014a,b,c can optionally have some or all of the components disclosed as being part of computing device 1001. In various further aspects, it is contemplated that some or all aspects of data processing described herein can be performed via cloud computing on one or more servers or other remote computing devices. Accordingly, at least a portion of the system 1000 can be configured with internet connectivity.

### EXAMPLE EMBODIMENT

### 1. Materials and Methods

The design of the multi-axis 3D printer is disclosed herein. Then, a procedure for 3D printing three-point bending samples comprising two segments with different print directions is described.

### 1.1 Multi-Axis 3D Printer Design

A multi-axis 3D printer was built on a commercially available four-column 3D printer platform (Ender-5 Pro, Creality, China). As shown in FIG. 2, the printer structure was modified to install a second print head orthogonal to the primary (first) print head. For this purpose, the frame of the printer was extended from one side to provide space for the second print head. In addition, the second print head was configured to have three degrees of motional freedom by adding a stepper motor driving the print head toward the print bed.

The print heads in the exemplary design can move independently, using two separate slicing software (Simplify 3D, US) for their control. Therefore, CAD models were sliced by the operator in order to print each segment using a chosen print head without collision between print heads. Since the print bed was not facing the second print head, the primary (first) print head can manufacture a model segment to provide a substrate for material deposition by the second print head. Also, a support section can be made by the primary print head in this design to provide space for the prevention of collision between the bed and the second print head assembly. Further aspects can comprise an extended nozzle head on the second print head to minimize the support dimensions and increase the printer's maneuverability.

### 1.2 Three-Point Bending Samples Preparation

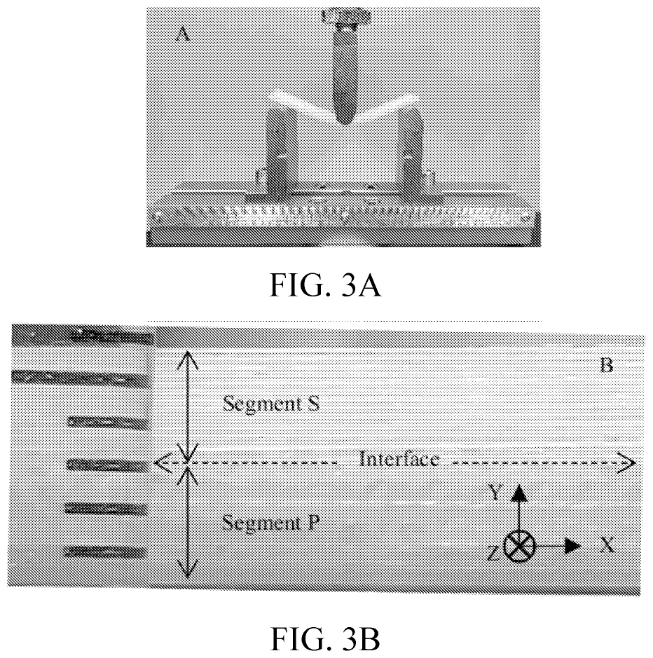

According to ASTM D790, three-point bending experiments were conducted on PLA samples prepared by the multi-axis 3D printer. The samples, shown in FIG. 3-B, had two segments bonded in their thickness direction during 3D printing. The first segment (segment P) was printed with the primary print head moving along X-Y directions. Segment S was manufactured consecutively by the second print head moving along X-Z directions. The model of segments' length, width, and depth were, respectively, 100, 15, and 2.5 mm. All print settings (nozzle temperature, infill density of 10%, extrusion flow rate, layer height of 0.2 mm, and extrusion nozzle orifice diameter) were the same for all samples.

The ratio of support span to depth for bending samples was 16. The testing configurations differed in whether segment P (condition 1) or segment S (condition 2) was in contact with the bending punch. Six samples for each configuration were tested at a 20 mm/min crosshead speed utilizing a universal testing machine (Instron 5982, US). The load-displacement curves were obtained, and maximum forces were recorded.

### 2. Results and Discussion

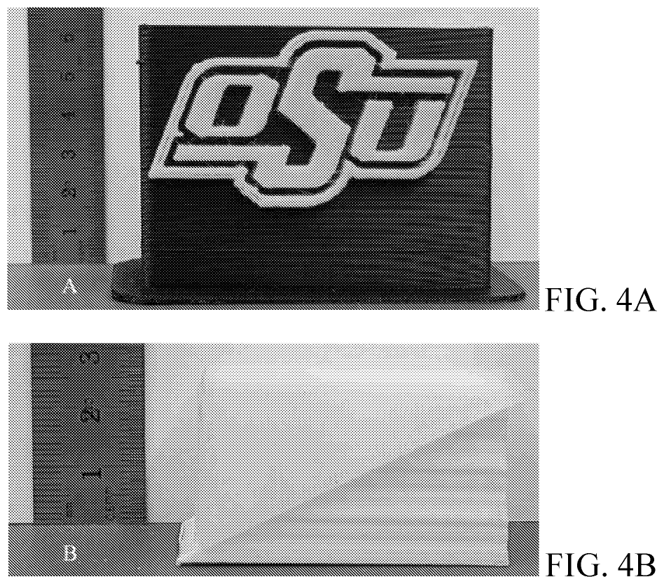

Different CAD models, shown in FIGS. 4A-4B, were printed to test the multi-axis 3D printer's functionality. The adhesion between segments was strong enough for each model, maintaining the structures' integrity under a qualitative drop test from about 1.5 m height on hard ground.

In addition, three-point bend tests provided a quantitative assessment of the products' flexural strength (of) and modulus of elasticity (EB). Equations (1) and (2) are used to calculate the maximum bending stress and modulus of elasticity. Since the samples are composed of two segments, the strength corresponded to the maximum load at the onset of interface debonding between segments or fracture of either segment.

$${σ}_{f} = 3 PL / ( 2 {bd}^{2} ) \qquad ( 1 )$$

$${E}_{B} = {mL}^{3} / ( 4 {bd}^{2} ) \qquad ( 2 )$$

where P is the maximum bending load, and b, d, and L are the samples' width, thickness, and support span, respectively. The parameter m is the slope of the tangent to the initial linear portion of the load-punch displacement curve.

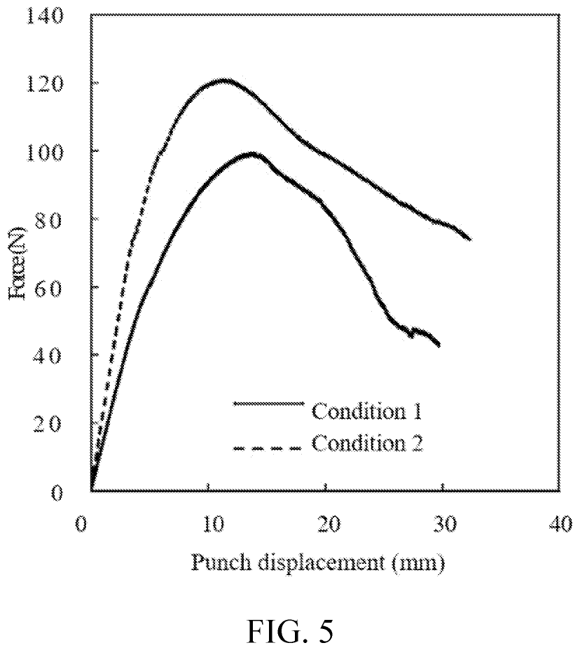

FIG. 5 shows a typical load-displacement curve for each testing condition. Segment P (see FIGS. 3A-3B) was in contact with the bending punch for test condition 1. For condition 2, segment S was in contact with the punch. The flexural strength and modulus of elasticity for both conditions are presented in Table 1.

For samples without interface fracture, the average flexural strength and modulus for condition 2 were about 16% higher than those for condition 1 (37.7 vs. 32.4 MPa for strength and 1.21 vs. 1.40 GPa for modulus of elasticity). However, the flexural strength of samples with interface fracture was 21.1 MPa for both conditions.

TABLE 1
Bending Properties of 3D Printed Samples

| | | Flexural | Bending Modulus |
|---|---|---|---|
| | | Strength | of Elasticity |
| | | (MPa) | (GPa) |
| Condition 1 | Average | 32.4 | 1.21 |
| | Standard Deviation | 2.47 | 0.23 |
| Condition 2 | Average | 37.7 | 1.40 |
| | Standard Deviation | 1.47 | 0.08 |

Higher flexural strength and modulus of elasticity for condition 2 can be attributed to the properties of segment P on the tension side of the bending sample. The friction between the punch and segment S for test condition 2 also contributed to the higher bending properties of the samples. The bending line was parallel to the built direction for segment P. The bending line was perpendicular to the built direction for segment S. It can, therefore, be inferred that the performance of the printed structure by the multi-axis printer depends on the loading conditions and segments' orientation.

The fracture of the segments' interface can be due to the change in their built orientation from one segment to the other. Further experimentation can determine the effect of print parameters on the strength of the interface between the segments. Nonetheless, it is contemplated that the multi-axis 3D printing process can customize the properties of the interface between segments. Therefore, the performance or fracture properties of 3D printed products can be customized to enhance the multifunctionality or repairability of the products.

### 2.1 Fractography

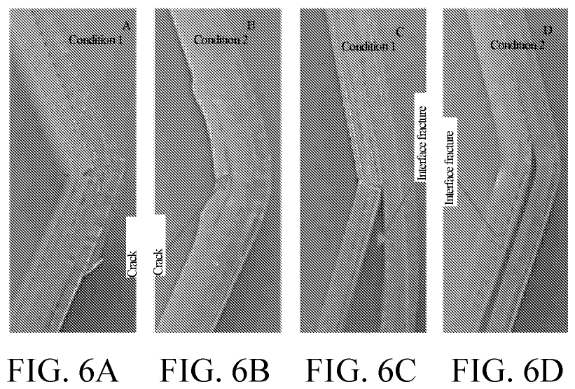

For condition 1, the fracture initiated at the outer fiber of segment S and propagated to segment P at the bending area, as shown in FIG. 6A. In this case, the crack propagated through the thickness, showing the effect of tensile stresses on the outer fibers of the specimen. For condition 2, fracture initiated either at the segments' interface or below the surface of segment S in contact with the punch. Although segment P was on the tension side of bending samples for condition 2, the fracture did not start at its outer fiber. FIG. 6B shows that the crack was perpendicular to the bending line. Also, buckling was observed at the sides of the punch contact area, confirming the effect of compressive forces on the buckling of fibers of segment S. The buckling eventually led to crack initiation and propagation different from condition 1 samples. In addition to these fracture types, some samples experienced the fracture at the interface between segments P and S, as shown in FIGS. 6C and 6D.

These observations confirm that segment S, or the interface between segments, was preferred for crack initiation regardless of loading conditions. It is summarized that crack initiation or fracture path can be customized by changing the printing orientations of segments of the products manufactured by multi-axis 3D printers.

### 3. CONCLUSION

The concept of multi-axis 3D printing disclosed herein enables manufacturing multifunctional materials with customized spatial properties. Therefore, it opens new horizons in additive manufacturing complex designs applicable in industries, including, but not limited to, medical, automotive, aerospace, appliances, packaging, and entertainment.

The disclosed multi-axis 3D printer and associated methods can enable production of unique and customizable geometry that is not possible or is prohibitively difficult to produce with conventional 3D printing. Further, the disclosed multi-axis 3D printer and associated methods can provide improved production rates over conventional 3D printers. Additionally, the disclosed multi-axis 3D printer and associated methods can enable customizable physical properties of the printed object. Moreover, multiple materials can be printed simultaneously or sequentially without cleaning, purging, or otherwise transitioning a single print head. Generally, the unique customizable geometries and customizable physical properties of the printed object can be enabled at least partly due to the ability to change the orientation of the printing as well as the ability to change the material printed. Further, by controlling direction of printing, adhesion of a printed filament can be controlled. Accordingly, embodiments disclosed herein can form objects that are less likely to delaminate than objects printed using conventional 3D printers.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A system having a vertical axis, a first horizontal axis that is perpendicular to the vertical axis, and a second horizontal axis that is perpendicular to the vertical axis and the first horizontal axis, the system comprising:
a printing platform;
a first print head that is configured to deposit material along a first deposition axis;
a second print head that is configured to deposit material along a second deposition axis that is not parallel to the first deposition axis; and
at least one actuator that is configured to cause relative movement between the printing platform and the first and second print heads along the vertical axis and the first and second horizontal axes.

Aspect 2: The system of aspect 1, wherein the first deposition axis is parallel to the vertical axis.

Aspect 3: The system of aspect 1 or aspect 2, wherein the second deposition axis is perpendicular to the first deposition axis.

Aspect 4: The system of any one of the preceding aspects, further comprising:
a third print head that is configured to deposit material along a third deposition axis that is not parallel to the first or second deposition axes;
wherein the at least one actuator that is configured to move the second print head along the vertical axis and the first and second horizontal axes.

Aspect 5: The system of aspect 4, wherein the third deposition axis is perpendicular to the first and second deposition axes.

Aspect 6: The system of any one of the preceding aspects, wherein the at least one actuator comprises:
a first linear actuator that is configured to move the printing platform relative to each of the first and second print heads along the vertical axis;
a second linear actuator that is configured to move the printing platform relative to each of the first and second print heads along the first horizontal axis; and
a third linear actuator that is configured to move the move the printing platform relative to each of the first and second print heads along the second horizontal axis.

Aspect 7: The system of any one of aspects 1-5, wherein the at least one actuator comprises:
a first linear actuator that is configured to move a respective one of the first or second print heads along the vertical axis;
a second linear actuator that is configured to move the respective print head along the first horizontal axis; and
a third linear actuator that is configured to move the respective print head along the second horizontal axis.

Aspect 8: The system of any one of the preceding aspects, further comprising a computing device, the computing device comprising at least one processor and a memory in communication with the at least one processor, wherein the memory comprises instructions that, when executed by the at least one processor, cause the system to:
move, by the at least one actuator, the first print head;
deposit, by the first print head, material to form a first portion of a printed object;
move, by the at least one actuator, the second print head relative to the first portion of the printed object; and
deposit, by the second print head, material to or on the first portion of the printed object to form a second portion of the printed object.

Aspect 9: The system of aspect 8, wherein the memory comprises instructions that, when executed by the at least one processor, cause the system to move the second print head relative to the first portion of the printed object based on known positions of deposition of material by the first print head.

Aspect 10: The system of aspect 8 or aspect 9, further comprising at least one sensor that is configured to detect spatial geometry of the first portion of the printed object,
wherein the memory comprises instructions that, when executed by the at least one processor, cause the system to:
   detect, by the at least one sensor, spatial geometry of the first portion of the printed object; and
   move the second print head relative to the first portion of the printed object based on the spatial geometry detected by the at least one sensor.

Aspect 11: The system of aspect 10, wherein at least one of the at least one sensor is an optical sensor.

Aspect 12: The system of aspect 10 or aspect 11, wherein at least one of the at least one sensor is a contact sensor.

Aspect 13: A method comprising: using the system as in any one of the preceding aspects.

Aspect 14: The method of aspect 13, comprising:
depositing material to form a support section on a printing platform of the system; and
depositing material to or on the support section to form a printed object.

Aspect 15: The method of aspect 14, wherein the support section has a sufficient dimension to permit the second print head to deposit material to or on the printed object or the support section.

Aspect 16: The method of aspect 14 or aspect 15, further comprising separating the support section from the printed object.

Those skilled in the art will recognize, or be able to ascertain using no more than routine experimentation, many equivalents to the specific embodiments of the method and compositions described herein. Such equivalents are intended to be encompassed by the following claims.

1. A system having a vertical axis, a first horizontal axis that is perpendicular to the vertical axis, and a second horizontal axis that is perpendicular to the vertical axis and the first horizontal axis, the system comprising:
a printing platform;
a first print head that is configured to deposit material along a first deposition axis;
a second print head that is configured to deposit material along a second deposition axis that is not parallel to the first deposition axis; and
at least one actuator that is configured to cause relative movement between the printing platform and the first and second print heads along the vertical axis and the first and second horizontal axes.

2. The system of claim 1, wherein the first deposition axis is parallel to the vertical axis.

3. The system of claim 1, wherein the second deposition axis is perpendicular to the first deposition axis.

4. The system of claim 1, further comprising:
a third print head that is configured to deposit material along a third deposition axis that is not parallel to the first or second deposition axes;
wherein the at least one actuator that is configured to move the second print head along the vertical axis and the first and second horizontal axes.

5. The system of claim 4, wherein the third deposition axis is perpendicular to the first and second deposition axes.

6. The system of claim 1, wherein the at least one actuator comprises:
a first linear actuator that is configured to move the printing platform relative to each of the first and second print heads along the vertical axis;
a second linear actuator that is configured to move the printing platform relative to each of the first and second print heads along the first horizontal axis; and
a third linear actuator that is configured to move the move the printing platform relative to each of the first and second print heads along the second horizontal axis.

7. The system of claim 1, wherein the at least one actuator comprises:
a first linear actuator that is configured to move a respective one of the first or second print heads along the vertical axis;
a second linear actuator that is configured to move the respective print head along the first horizontal axis; and
a third linear actuator that is configured to move the respective print head along the second horizontal axis.

8. The system of claim 1, further comprising a computing device, the computing device comprising at least one processor and a memory in communication with the at least one processor, wherein the memory comprises instructions that, when executed by the at least one processor, cause the system to:
move, by the at least one actuator, the first print head;
deposit, by the first print head, material to form a first portion of a printed object;
move, by the at least one actuator, the second print head relative to the first portion of the printed object; and
deposit, by the second print head, material to or on the first portion of the printed object to form a second portion of the printed object.

9. The system of claim 8, wherein the memory comprises instructions that, when executed by the at least one processor, cause the system to move the second print head relative to the first portion of the printed object based on known positions of deposition of material by the first print head.

10. The system of claim 8, further comprising at least one sensor that is configured to detect spatial geometry of the first portion of the printed object,
wherein the memory comprises instructions that, when executed by the at least one processor, cause the system to:
detect, by the at least one sensor, spatial geometry of the first portion of the printed object; and
move the second print head relative to the first portion of the printed object based on the spatial geometry detected by the at least one sensor.

11. The system of claim 10, wherein at least one of the at least one sensor is an optical sensor.

12. The system of claim 10, wherein at least one of the at least one sensor is a contact sensor.

13. A method comprising: using the system in claim 1 to deposit material along at least one of the first deposition axis or the second deposition axis.

14. The method of claim 13, comprising:
depositing material to form a support section on a printing platform of the system; and
depositing material to or on the support section to form a printed object.

15. The method of claim 14, wherein the support section has a sufficient dimension to permit the second print head to deposit material to or on the printed object or the support section.

16. The method of claim 14, further comprising separating the support section from the printed object.
